(19) United States
(12) Patent Application Publication
(10) Pub. No.: US 2007/0159349 A1
(43) Pub. Date: Jul. 12, 2007

(54) Wireless remote control method

(75) Inventors: Chia-Ming Chang, Chu-Tung (TW); Cheng-Ting Lin, Chu-Tung (TW); Chun-Yu Chen, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/417,116

(22) Filed: May 4, 2006

(30) Foreign Application Priority Data
Dec. 23, 2005 (TW) 94146141

(51) Int. Cl. G05B 19/02

(52) U.S. Cl. 340/825.22; 340/825.72; 341/176; 340/825.69

(57) ABSTRACT

A wireless remote control method enables a remote controller to control a plurality of controlled electrical appliances through a turner. The remote controller searches at least one accessible controlled electrical appliance through a transmission packet of a wireless communication protocol. The turner provides at least one accessible controlled electrical appliance to the remote controller. The remote controller sends linking request sequence of each key of the remote controller to the turner. The controlled electrical appliance sends supportable function link request sequence of the controlled electrical appliance to the turner. The remote controller is linked with the controlled electrical appliance for remotely controlling the controlled electrical appliance.

### 1. FIELD OF THE INVENTION

The present invention relates to a wireless remote control method, especially to a wireless remote control method to integrate the remote control function for various electrical appliances to a remote controller or a hand-held device, an a wireless remote control system using household electrical appliance communication protocol such as SAA NET or short-distance wireless communication technology.

### 2. DESCRIPTION OF PRIOR ART

Many household electrical appliances are equipped with remote controller for controlling electrical appliances remotely by wireless signal. However, too many remote controllers will cause troublesome to user. Therefore, a universal remote controller is developed to integrate a plurality of remote function modes of electrical appliances into one universal remote controller. Many electrical appliances can be remotely controlled by using this universal remote controller.

However, the setting of the conventional universal remote controller is generally complicated. For example, the universal remote controller for television and audio set cannot be used to control air conditioner because of great functional difference.

There is control protocol defined for future electrical appliance control, for example SAA NET is proposed. The electrical appliance manufactures can design electrical appliance based on the control protocol and the future electrical appliances can be interconnected for work. However, the conventional universal remote controller cannot be compatible with the control protocol for future electrical appliance.

The prior art remote controllers are generally related to hardware design and do not teach operation mode and interconnection setting between remote controller and electrical appliance. For example, Taiwan Pat. No. 531980 entitled “Learning method for wireless remote controller” discloses a learning process for identity. However, this patent does not disclose a concrete process to realize this function. Taiwan Pat. No. 468894 entitled “Smart universe remote controller” discloses a method to automatically select a remote controller type according to brand, year, model, country, serial number, and key number of the remote controller. However, this patent also does not disclose a concrete process to realize this function.

### SUMMARY OF THE INVENTION

It is the object of the present invention to provide a wireless remote control method and system to integrate the remote control function for various electrical appliances to a remote controller or a hand-held device. The a wireless remote control method and system uses short-distance wireless communication technology for providing compatibility of future electrical appliance protocol.

Accordingly, the present invention provides a wireless remote control method to enable a remote controller to control a plurality of controlled electrical appliances through a turner. The remote controller searches at least one accessible controlled electrical appliance through a transmission packet of a wireless communication protocol. The turner provides at least one accessible controlled electrical appliance to the remote controller. The remote controller sends linking request sequence of each key of the remote controller to the turner. The controlled electrical appliance sends supportable function link request sequence of the controlled electrical appliance to the turner. The remote controller is linked with the controlled electrical appliance for remotely controlling the controlled electrical appliance.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of the wireless remote control system according to a first preferred embodiment of the present invention.

FIG. 2 shows the packet structure of Zigbee protocol.

FIG. 3 shows the block diagram of the wireless remote control system according to a second preferred embodiment of the present invention.

FIG. 4 shows the flowchart of the communication transmission process according to the present invention.

### DETAILED DESCRIPTION OF THE INVENTION

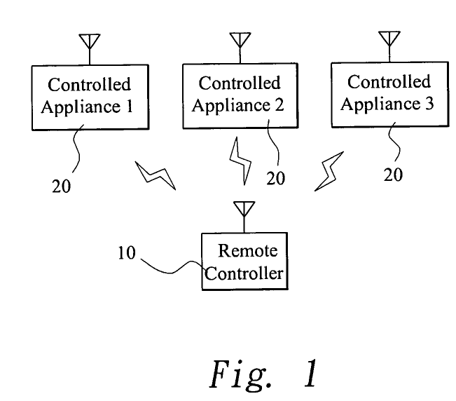

FIG. 1 shows the block diagram of the wireless remote control system according to a first preferred embodiment of the present invention. The present invention provides a wireless remote control system to integrate the remote control function for various electrical appliances. The universal remote controller 10 according to the present invention has integrated with protocol for future electrical appliances and short-distance wireless communication skill. The universal remote controller 10 can be built into a hand-held device such as a mobile phone or a PDA, whereby the mobile phone and PDA can directly remote-control a plurality of controlled electrical appliances 20.

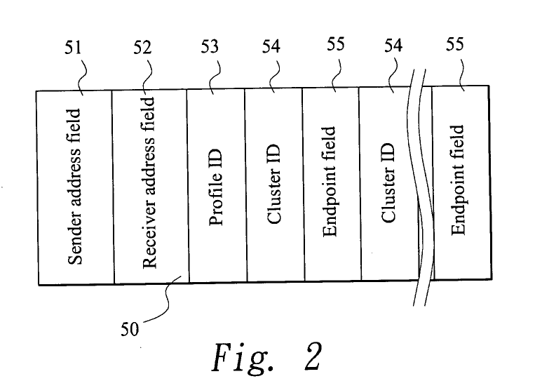

The wireless remote control system according to the first preferred embodiment of the present invention uses existing wireless communication protocol to transmit signal. For example, Zigbee protocol, Ultra Wide Band protocol or Bluetooth can be used. In the present invention, the wireless remote control system is exemplified with Zigbee protocol. FIG. 2 shows the packet structure of the Zigbee protocol. All device complied with the Zigbee protocol can transmit and receive message. A wireless network is formed when all devices, including the remote controller 10 and the controlled electrical appliances 20, are connected wirelessly. The packet comprises at least one sender address field 51, receiver address field 52, profile ID 53, cluster ID 54 and a plurality of endpoint fields 55.

The profile ID 53 indicate application types, namely types of electrical appliances, such as air conditioner, television, DVD player. The cluster ID 54 indicates function types such as power on/off of air conditioner, PLAY/STOP o DVD player. The endpoint fields 55 indicate the accessing terminals with the same function. According to the present invention, the remote controller 10 and the controlled electrical appliances 20 can be interconnected remotely for control when they use the same profile ID 53, cluster ID 54 and endpoint fields 55.

The present invention uses packet table of Zigbee protocol to define the wireless transmission structure, which comprises
(aₛ,eₛ,cₛ)={(a_{d1},e_{d1}),(a_{d2},e_{d2}), . . . , (a_{dn},e_{dn})}

where aₛ indicates the link packet for source device address;

eₛ indicates the link packet for the terminal symbol of the source device;

cₛ indicates the cluster symbol used in link packet;

a_{d1} indicates the link packet for the iₜₕ destination address; and

e_{d1} indicates the link packet for the terminal symbol of iₜₕ destination.

According to the above-mentioned wireless transmission protocol, after the profile ID 53, cluster ID 54 and endpoint fields 55 are defined for the electrical appliances, the remote control function for the electrical appliances can be provided. The ID for the electrical appliances is compatible with the ID defined by the current electrical appliances protocol such as SAA NET and compatible with future electrical appliances.

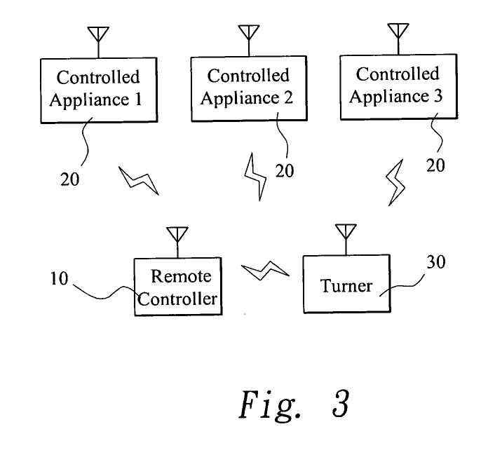

FIG. 3 shows the block diagram of the wireless remote control system according to a second preferred embodiment of the present invention. The electrical appliances 20 are interconnected with the remote controller 10 through a tuner 30. The tuner 30 is stored with various control functions of electrical appliances 20 and communication protocols and performs conversion between the key function of the remote controller 10 and the operation of the electrical appliances 20. Moreover, the tuner 30 can automatically learn the control function between the electrical appliances 20 and the remote controller 10.

When the remote controller is used for television and DVD player, part of functions use the same buttons, such as channel change and volume up/down. In conventional remote controller, the related functions should be preset to prevent wrong operation. In the present invention, the turner 30 performs the conversion function and use does not need to set the conversion. The tuner 30 can link the key function of the remote controller 10 and the key function of the electrical appliances 20 to achieve the conversion.

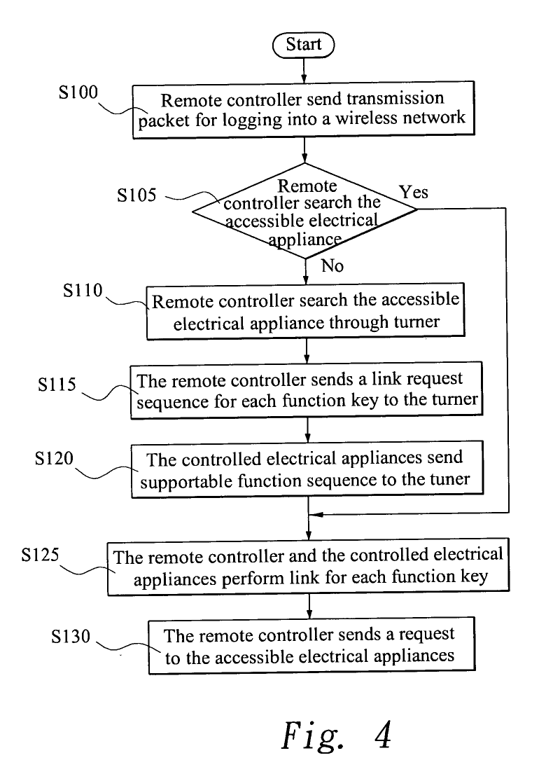

FIG. 4 shows the flowchart of the communication transmission process according to the present invention. The method for operating the wireless remote control system according to the present invention comprises following steps. In step S100, the remote controller 10 sends transmission packet 50 containing remote controller information wirelessly for authorization and for logging into a wireless network of the electrical appliances 20. In step 105, the remote controller 10 searches the accessible electrical appliances 20 in the wireless network. If at least one accessible electrical appliance 20 is found, the process moves to step S125, else the remote controller 10 searches the accessible electrical appliances 20 in the wireless network through the turner in step S110. The remote controller 10 sends a link request sequence including link request of each key (function key) to the turner 30 in step S115. The controlled electrical appliances 20 send supportable function sequence to the tuner 30 in step S120 for operation reference. The remote controller 10 and the controlled electrical appliances 20 perform link for each function key in step S125. After the link is established, the remote controller 10 sends a request to the accessible electrical appliances 20 in step S130 to control remotely the accessible electrical appliances 20.

The link between the remote controller 10 and the controlled electrical appliances 20 can be performed for one function key instead of all function keys. When user presses a learn function key on the remote controller 10, the turner 30 will stores information sent from the remote controller 10. When a specific function key is pressed on the controlled electrical appliances 20 within a predetermined period, the turner 30 will store corresponding packets from the remote controller 10 and the controlled electrical appliances 20 for establishing a link. Therefore, the turner 30 will activates the link for function key of the remote controller 10 and the function key of the controlled electrical appliances 20 when the same function key of the remote controller 10 is pressed. The turner will not wait for the packet sent from the controlled electrical appliances 20 when the predetermined period is expired.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A wireless remote control method enabling a remote controller to control a plurality of controlled electrical appliances through packet of a wireless communication protocol, the method comprising
the remote controller searching at least one accessible controlled electrical appliance;
linking the remote controller with the accessible controlled electrical appliance; and
linking at least one function key of the remote controller with an operation function of the controlled electrical appliance for remote control operation.

2. The wireless remote control method as in claim 1, wherein the wireless communication protocol is a Zigbee protocol.

3. The wireless remote control method as in claim 1, wherein the wireless communication protocol is an Ultra Wide Band protocol.

4. The wireless remote control method as in claim 1, wherein the wireless communication protocol is a Bluetooth protocol

5. The wireless remote control method as in claim 1, wherein the packet of the wireless communication protocol comprises at least one at least one sender address field, receiver address field, profile ID, cluster ID and a plurality of endpoint fields.

6. The wireless remote control method as in claim 5, wherein the Profile ID indicates types of electrical appliances.

7. The wireless remote control method as in claim 5, wherein the Cluster ID indicates specific functions of electrical appliances.

8. The wireless remote control method as in claim 5, wherein the remote controller can be linked with the controlled electrical appliance when they have the same profile ID, cluster ID and endpoint fields.

9. The wireless remote control method as in claim 1, wherein packet table for network transmission has following definition:
(aₛ,eₛ,cₛ)={(a_{d1},e_{d1}),(a_{d2},e_{d2}), . . . ,(a_{d1},e_{dn})}
where aₛ indicates the link packet for source device address;
eₛ indicates the link packet for the terminal symbol of the source device;
cₛ indicates the cluster symbol used in link packet;
a_{d1} indicates the link packet for the iₜₕ destination address; and
e_{d1} indicates the link packet for the terminal symbol of iₜₕ destination.

10. A wireless remote control method enabling a remote controller to control a plurality of controlled electrical appliances through a turner, the method comprising
the remote controller searching at least one accessible controlled electrical appliance through a transmission packet of a wireless communication protocol;
the turner providing at least one accessible controlled electrical appliance to the remote controller;
sending linking request sequence of each key of the remote controller to the turner;
sending supportable function link request sequence of the controlled electrical appliance to the turner; and
linking the remote controller with the controlled electrical appliance for remotely controlling the controlled electrical appliance.

11. The wireless remote control method as in claim 10, wherein the wireless communication protocol is a Zigbee protocol.

12. The wireless remote control method as in claim 10, wherein the wireless communication protocol is an Ultra Wide Band protocol.

13. The wireless remote control method as in claim 10, wherein the wireless communication protocol is a Bluetooth protocol.

14. The wireless remote control method as in claim 10, wherein the packet of the wireless communication protocol comprises at least one at least one sender address field, receiver address field, profile ID, cluster ID and a plurality of endpoint fields.

15. The wireless remote control method as in claim 14, wherein the Profile ID indicates types of electrical appliances.

16. The wireless remote control method as in claim 14, wherein the Cluster ID indicates specific functions of electrical appliances.

17. The wireless remote control method as in claim 14, wherein the remote controller can be linked with the controlled electrical appliance when they have the same profile ID, cluster ID and endpoint fields.

18. The wireless remote control method as in claim 14, wherein packet table for network transmission has following definition:
(aₛ,eₛ,cₛ)={(a_{d1},e_{d1}),(a_{d2},e_{d2}), . . . , (a_{dn},e_{dn})}
where aₛ indicates the link packet for source device address;
eₛ indicates the link packet for the terminal symbol of the source device;
cₛ indicates the cluster symbol used in link packet;
a_{d1} indicates the link packet for the iₜₕ destination address; and
e_{d1} indicates the link packet for the terminal symbol of iₜₕ destination.
